(19) United States
(12) Patent Application Publication
(10) Pub. No.: US 2020/0216729 A1
(43) Pub. Date: Jul. 9, 2020

(54) REACTIVE ADHESIVES HAVING A LOW MONOMERIC DIISOCYANATE CONTENT

(71) Applicant: Evonik Operations GmbH, Essen (DE)

(72) Inventors: Nicolai Kolb, Recklinghausen (DE); Gabriele Brenner, Dülmen (DE)

(73) Assignee: Evonik Operations GmbH, Essen (DE)

(21) Appl. No.: 16/638,541

(22) PCT Filed: Aug. 29, 2018
(86) PCT No.: PCT/EP2018/073224

§ 371 Date: Feb. 12, 2020

(30) Foreign Application Priority Data
Aug. 31, 2017 (EP) 17188861.3

(51) Int. Cl. C09J 175/06; C08G 18/42; C08G 18/76; C09J 5/00; C08J 5/12; B32B 7/12; B32B 21/08

(52) U.S. Cl. CPC C09J 175/06; C08G 18/4208; C08G 18/7671; C09J 5/00; C08J 5/128; C08J 2397/02; B32B 21/08; C09J 2475/00; C09J 2400/166; C09J 2400/306; C08J 2475/06; B32B 7/12

(57) ABSTRACT

The present invention relates to a reactive adhesive comprising the reaction product of a polyester, constructed from the monomers A, B and C, where A=phthalic acid or phthalic anhydride, B=at least one organic acid having at least two acid groups or the corresponding anhydride or the corresponding ester, with the proviso that B is not A, and C=at least one diol, and that the molar ratio of the monomers A to monomers B is from 1:10 to 10:1, as polyol and optionally one or more further polyols, with a diisocyanate, which is characterized in that the average OH number of the polyols used is from 10 to 30 mg KOH/g polyols, the ratio of OH of the polyols used to NCO groups of the diisocyanate used is from 1:1.2 to 1:4.0, and the reaction product has a viscosity of 1 to 200 Pa*s at 130° C. and also a method for production thereof and also use of the reactive adhesive.

### CROSS REFERENCE TO RELATED APPLICATIONS

This application is a 35 U.S.C. § 371 U.S. national phase entry of International Application No. PCT/EP2018/073224 having an international filing date of Aug. 29, 2018, which claims the benefit of European Application No. 17188861.3 filed Aug. 31, 2017, each of which is incorporated herein by reference in its entirety.

### FIELD

The present invention relates to a reactive adhesive comprising the reaction product of a polyester, constructed from the monomers A, B and C, where A=phthalic acid or phthalic anhydride, B=at least one organic acid having at least two acid groups or the corresponding anhydride or the corresponding ester, with the proviso that B is not A, and C=at least one diol, and that the molar ratio of the monomers A to monomers B is from 1:10 to 10:1, preferably 2:8 to 9:1, as polyol and optionally one or more further polyols, with a diisocyanate, which is characterized in that the average OH number of the polyols used is from 10 to 30 mg KOH/g polyols, the ratio of OH of the polyols used to NCO groups of the diisocyanate used is from 1:1.2 to 1:4.0, and the reaction product has a viscosity of 1 to 200 Pa*s at 130° C. and also a method for production thereof and also use of the reactive adhesive.

### BACKGROUND

(Co)polyesters, also referred to here simply as polyesters, are used in a multiplicity of end uses. For example, they are used as constituent in adhesives, as binders for metal coatings, for example interior coatings of tin cans, as binders for film coatings or even as constituent in film production.

An example of the use of polyesters in adhesives are reactive adhesives, especially moisture-curing reactive adhesives (reactive hot melts—RHM or PU hot melts). These RHM are typically produced by the reaction of OH-functionalized polymers (polyols) with diisocyanate.

In this case, an excess amount of diisocyanate is typically used, thereby obtaining NCO-terminated polymers (so-called prepolymers). These prepolymers are obtained here as mixtures of NCO-terminated polymers, which are constructed from one or more repeating units of the polyol linked via the diisocyanate. In addition, owing to the excess amount of diisocyanate used, the mixture of the prepolymers after the reaction comprises residual amounts of monomeric diisocyanate. On account of the critical toxicity classification of diisocyanates, such as methylene diphenyl isocyanate (4,4′-MDI) for example, it is desirable to keep the content of such monomeric diisocyanate in the finished prepolymer or RHM as low as possible.

There are diverse methods of decreasing the content of monomeric diisocyanate remaining in the RHM. Without going into the methods in more detail, these would be:
use of polymeric diisocyanate in the reaction with the polyol (DE10055786)
use of diisocyanates with differently reactive NCO groups (stereoselectivity). (EP1458780 and DE10229519)
distillation of diisocyanate from the finished product (EP1241197)
subsequent reaction of the free NCO to a chemical bond, for example by carrying out a trimerization reaction (DE10229780 and DE10229781) or the further reaction with a moisture-curing reagent such as mercaptosilane (EP2664637)

A further possibility is the use of polymers (polyols) with relatively high molecular weight.

Generally in the production of the RHM or prepolymers, the weight ratio of polyol to diisocyanate is determined by the ratio of
OH number (polyol):NCO number (diisocyanate).

The starting weight of the diisocyanate arises therefrom. Typically, an excess is selected in the range of OH: NCO from 1.0:1.5-1.0:3.0.

In the case of a specified isocyanate-4,4′-MDI for example—the NCO number is constant. The weight ratio of polyol to isocyanate is thus influenced by the OHN of the polyol. In the case of polyols having relatively low OH numbers, a proportionately lower amount of diisocyanate is correspondingly used.

A simple possibility to reduce the content of monomeric diisocyanate remaining in RHM would therefore be the use of polyols having relatively low OHN—i.e. corresponding to relatively high molecular weight. A disadvantage in this case, however, is that by increasing the molecular weight, the viscosity of the polyol likewise rises exponentially.

On the basis of polyesters—these are frequently used as polyols for producing RHM—this increase in viscosity is critical, particularly for amorphous polyesters. Due to the nature of the aromatic monomers frequently used here (for example terephthalic acid or isoterephthalic acid), amorphous polyesters have a very high viscosity. If the molecular weight of existing amorphous polyesters is significantly increased, the viscosity increases into ranges which is no longer manageable for use in reactive hotmelt adhesives since sufficient wetting of the substrate to be bonded using the adhesive is no longer ensured.

Amorphous polyesters, however, are of essential significance for the production of reactive adhesives (RHM) since high initial strength of the adhesive is obtained by adding amorphous polyesters.

### SUMMARY

The object of the present invention, therefore, was the provision of reactive adhesives based on polyesters which have a low content of monomeric diisocyanate remaining (preferably less than 2% by weight) and have a viscosity which further enables use as a reactive adhesive.

It has been found that, surprisingly, reactive adhesives comprising the reaction product of a polyester with a minimum proportion of phthalic acid or phthalic anhydride as monomer and a diisocyanate, can meet these requirements.

The present invention therefore relates to reactive adhesives comprising the reaction product of a polyester, comprising phthalic acid or phthalic anhydride as monomer, with a diisocyanate as defined in the claims and the subsequent description.

The present invention also relates to a method for producing the reactive adhesives according to the invention and use thereof.

### DETAILED DESCRIPTION

The reactive adhesives according to the invention have the advantage that, owing to the low OHN itself at an excess of diisocyanate used of OH:NCO from 1.0:1.2 to 1.0:4.0, they have a relatively low content of monomeric diisocyanate but at the same time a low viscosity. In existing systems having relatively high OHN, a correspondingly low content of monomeric diisocyanate would only be possible if the excess OH:NCO would be lowered, which would result in a substantial construction of oligomeric polyurethane and corresponding viscosity increase.

The reactive adhesives according to the invention, the method for the production thereof according to the invention and the use of the reactive adhesives according to the invention are described hereinbelow by way of example without any intention to restrict the invention to these exemplary embodiments. When ranges, general formulae or classes of compounds are specified below, these are intended to encompass not only the corresponding ranges or groups of compounds which are explicitly mentioned but also all subranges and subgroups of compounds which can be obtained by leaving out individual values (ranges) or compounds. Where documents are cited in the context of the present description, their content shall fully form part of the disclosure content of the present invention, particularly in respect of the matters referred to. Percentages specified hereinbelow are by weight unless otherwise stated. Average values, molar mass average values for example, specified hereinbelow are number averages unless otherwise stated. Where properties of a material are referred to hereinbelow, for example viscosities or the like, these are properties of the material at 25° C. unless otherwise stated. When chemical (empirical) formulae are used in the present invention, the reported indices may be either absolute numbers or average values. The indices relating to polymeric compounds are preferably average values.

The reactive adhesive according to the invention comprising the reaction product of a polyester, preferably amorphous polyester, constructed from the monomers A, B and C, where A=phthalic acid or phthalic anhydride, B=at least one organic acid having at least two acid groups or the corresponding anhydride or the corresponding ester, with the proviso that B is not A, and C=at least one diol, in which the molar ratio of the monomers A to monomers B is from 1:10 to 10:1, preferably 2:8 to 9:1, as polyol and optionally one or more further polyols, with a diisocyanate, is characterized in that the average OH number of the polyols used is from 10 to 30 mg KOH/g polyols, the ratio of OH of the polyols used to NCO groups of the diisocyanate used is from 1:1.2 to 1:4.0, preferably from 1:1.6 to 1:2.5, and the reaction product has a viscosity of 1 to 200 Pa*s at 130° C.

The monomers C may comprise one diol, two different diols C1 and C2 or more diols C1 to Cx. The monomer C preferably comprises at least or exactly two different diols C1 and C2. Preferred monomers C are monoethylene glycol, diethylene glycol, butylethylpropanediol, 1,2-propanediol, 1,3-propanediol, 1,4-butanediol, 1,6-hexanediol, neopentyl glycol, 1,3-methylpropanediol and/or 1,5-methylpentanediol. Monomer C1 is particularly preferably monoethylene glycol and monomer C2 is particularly preferably neopentyl glycol or 1,3-methylpropanediol.

The monomers B can be one or more organic acids. If the monomers B are two or more organic acids, they are preferably at least two different organic acids.

The monomer(s) B is/are preferably at least one acid selected from terephthalic acid, isoterephthalic acid, adipic acid and succinic acid.

The polyesters preferably have an OH number of less than 28 mg KOH/g, preferably from 10 to 26 mg KOH/g, particularly preferably from 12 to 24 mg KOH/g. A sufficiently high molecular weight of the polyester is ensured by this value in order to obtain a content of monomeric diisocyanate of <2% by weight in the reactive adhesive according to the invention.

The polyesters preferably have a viscosity at 130° C. of less than 100 Pa*s, preferably less than 80 Pa*s.

The polyesters preferably have a glass transition temperature of 20° C. to 60° C., preferably 25 to 55° C.

Particular preference is given to polyesters having either a glass transition temperature of 30+/−10° C., preferably 30+/−5° C. and a viscosity at 130° C. of less than 20 Pa*s, preferably 1 to 15 Pa*s or a glass transition temperature of 48+/−10° C., preferably 48+/−5° C. and a viscosity at 130° C. of less than 100 Pa*s, preferably greater than 30 to less than 80 Pa*s.

As optional further polyols in the reactive adhesive according to the invention, polyester polyols, polyether polyols and any hydroxy-functional components may be used for example. The selection of these optional polyols is arbitrary. However, the polyols used should not substantially increase the average OHN of the formulation, preferably by not more than 10%.

As optional further polyester polyols for example, liquid or solid, amorphous or (semi)crystalline polyesters may be used having molecular weights with a number average between 2000 g/mol and 30 000 g/mol, preferably between 3000 g/mol and 10 000 g/mol (calculated from the hydroxyl number), preference being given to using linear polyester polyols.

The optional polyether polyols used may be, for example, polyether diols or polyether triols. Examples of these are, for example, homo- and copolymers of ethylene glycol, propylene glycol and butane-1,4-diol. The molecular weight (number average) of the polyether polyols added should preferably be within a range from 2000 g/mol to 30 000 g/mol, preferably between 3000 g/mol and 10 000 g/mol.

The optional arbitrary hydroxy-functional components used are preferably hydroxy-functional polyolefins such as hydroxy-functional polybutadienes, hydroxy-functional polyisoprenes, hydroxy-functional polyolefins, hydroxy-functional polycarbonates or hydroxy-functional polyacrylates.

To prepare the reactive adhesive according to the invention, diisocyanates used are preferably aromatic, aliphatic and/or cycloaliphatic isocyanates, carbodiimide-modified isocyanates or isocyanate-terminated prepolymers. Preferred diisocyanates are diphenylmethane 4,4′-diisocyanate, diphenylmethane 2,4′-diisocyanate, toluene diisocyanate isomers, isophorone diisocyanate, hexamethylene diisocyanate, dicyclohexylmethane 4,4′-diisocyanate and mixtures thereof. Particularly preferred diisocyanates are diphenylmethane 4,4′-diisocyanate and mixtures of diphenylmethane 4,4′-diisocyanate and diphenylmethane 2,4′-diisocyanate.

In addition to the reaction product, the reactive adhesives according to the invention may comprise further additives, to an extent of up to 50% by weight, preferably from 5 to 40% by weight, based on the overall formulation, particularly additives for example which ensure improved stability to hydrolysis. These additives may be, for example: non-functionalized polymers, for example thermoplastic polyurethanes (TPUs) and/or polyacrylates and/or ethylene-vinyl acetate copolymers (EVA); pigments or fillers, for example talc, silicon dioxide, titanium dioxide, barium sulfate, calcium carbonate, carbon black or color pigments; tackifiers, for example rosins, hydrocarbon resins, phenolic resins, and ageing stabilizers and auxiliaries.

The reactive adhesives according to the invention are preferably reactive hotmelt adhesives (RHM), which are additionally chemically cross-linked following application by moisture (for example air humidity or moist substrates).

The reactive adhesives according to the invention can be produced by conventional methods in which polyols are reacted with diisocyanates. The reactive adhesives according to the invention are preferably produced by the method according to the invention as described below.

The method according to the invention for producing a reactive adhesive, particularly a reactive adhesive according to the invention, in which the monomers A, B and C are esterified, where A=phthalic acid or phthalic anhydride, B=at least one organic acid having at least two acid groups or the corresponding anhydride or the corresponding ester, with the proviso that B is not A, and C=at least one diol, wherein the molar ratio of the monomers A to monomers B is from 1:10 to 10:1, preferably 2:8 to 9:1, and this polyester as polyol, optionally in the presence of one or more further polyols, is reacted with at least one diisocyanate, is characterized in that the average OH number of the polyols used is from 10 to 30 mg KOH/g polyols and the ratio of OH groups of the polyols used to NCO groups of the diisocyanates used is from 1:1.2 to 1:4.0, preferably from 1:1.6 to 1:2.5.

The polyesters are preferably synthesized via a melt condensation. For this purpose, the aforementioned monomers are preferably initially charged and melted in an equivalents ratio of hydroxyl to carboxyl groups of 0.5 to 1.5, preferably 1.0 to 1.3. The polycondensation preferably takes place in the melt preferably at temperatures from 150 to 280° C. preferably over the course of 3 to 30 hours.

It may be advantageous if a majority of the amount of water released is initially distilled off at standard pressure. In the further course, the remaining water of reaction and volatile diols are preferably eliminated, until the target molecular weight is achieved. Optionally this may be made easier through reduced pressure, through an enlargement in the surface area, or by the passing of an inert gas stream through the reaction mixture.

The esterification can additionally be accelerated by addition of an azeotrope former and/or of a catalyst, before or during the reaction. Examples of suitable azeotrope formers are toluene and xylenes. Preferred catalysts are organotitanium or organotin compounds such as tetrabutyl titanate or dibutyltin oxide and catalysts based on other metals such as zinc or antimony, and also metal-free esterification catalysts.

Furthermore, it may be advantageous to add further additives and processing auxiliaries, such as antioxidants or color stabilizers, to the esterification mixture.

To produce the polyesters according to the invention, generally there are in principle no limitations with respect to the monomers B (di- or polycarboxylic acids) and C (diols or polyols) and in principle all mixing ratios with respect to the monomers B and monomers C may be used. The selection is guided by the desired physical properties of the polyester.

The monomers B used in accordance with the invention are carboxylic acids bearing two or more carboxyl groups or anhydrides or esters thereof. The monomers B may preferably be aromatic or saturated or unsaturated aliphatic or saturated or unsaturated cycloaliphatic di- or polycarboxylic acids. Preference is given to using dicarboxylic acids. Preferred aromatic carboxylic acids used are compounds such as dimethyl terephthalate, terephthalic acid and isophthalic acid.

Preferred linear aliphatic carboxylic acids used are, for example, succinic acid, dimethyl succinate, adipic acid, dimethyl adipate, azelaic acid, dimethyl azelate, sebacic acid, dimethyl sebacate, undecanedicarboxylic acid, 1,10-decanedicarboxylic acid, 1,12-dodecanedicarboxylic acid, brassylic acid, 1,14-tetradecanedicarboxylic acid, 1,16-hexadecanedioic acid, 1,18-octadecanedioic acid and mixtures thereof.

Preferred saturated cycloaliphatic carboxylic acids used are 1,4-cyclohexanedicarboxylic acids, 1,3-cyclohexanedicarboxylic acids or 1,2-cyclohexanedicarboxylic acids.

It is possible in principle to use any desired monomers C for the preparation of the polyesters. Monomers C are understood to mean compounds bearing two or more hydroxyl groups. For instance, linear or branched aliphatic and/or cycloaliphatic and/or aromatic diols or polyols may be used. Preference is given to using compounds bearing exactly two hydroxyl groups.

Examples of suitable monomers C are ethylene glycol, propanediol-1,2, propanediol-1,3, butanediol-1,4, butanediol-1,3, butanediol-1,2, butanediol-2,3, pentanediol-1,5, hexanediol-1,6, octanediol-1,8, nonanediol-1,9, dodecanediol-1,12, neopentyl glycol, butylethylpropanediol-1,3, methylpropanediol-1,3, methylpentanediols, cyclohexanedimethanols, tricyclo[2.2.1]decanedimethanol, isomers of limonenedimethanol, isosorbitol, trimethylolpropane, glycerol, 1,2,6-hexanetriol, pentaerythritol, polyethylene glycol, polypropylene glycol and mixtures thereof, but also reaction products of aromatic polyhydroxy compounds such as hydroquinone, bisphenol A, bisphenol F, dihydroxynaphthalene etc. with epoxides such as ethylene oxide or propylene oxide or ether diols, i.e. oligomers or polymers, for example based on ethylene glycol, propylene glycol or butanediol-1,4, or trimethylolpropane, pentaerythritol or glycerol.

The monomers C used in the method according to the invention are preferably two different diols C1 and C2. Preferred monomers C are monoethylene glycol, diethylene glycol, butylethylpropanediol, 1,2-propanediol, 1,3-propanediol, 1,4-butanediol, 1,6-hexanediol, neopentyl glycol, 1,3-methylpropanediol and/or 1,5-methylpentanediol. Monomer C1 is particularly preferably monoethylene glycol and monomer C2 is particularly preferably neopentyl glycol or 1,3-methylpropanediol.

Preference is given to using diols as monomers C and dicarboxylic acids as monomers B.

It may be advantageous if lactones and hydroxycarboxylic acids are used as further monomers for producing the polyester.

The polyesters obtained in the esterification preferably have at least one hydroxyl and/or carboxyl end group; the functionality is preferably 1.0 to 4.0, particularly preferably 1.5 to 3.0.

The concentration of acid end groups, determined in accordance with DIN EN ISO 2114, is preferably between 0 and 10 mg KOH/g, but preferably below 2 mg KOH/g.

The number-average molecular weight of the polyesters used in accordance with the invention is preferably 2000-30 000 g/mol, preferably 3000-10 000 g/mol. It is determined in accordance with DIN 55672-1 by means of gel permeation chromatography in tetrahydrofuran as eluent and polystyrene for calibration.

The proportion of the polyester used in accordance with the invention in the formulation (without additives) is, based on the overall formulation, preferably from 1 to 95 percent by weight, preferably from 5 to 60 percent by weight and particularly preferably from 10 to 50 percent by weight. In this manner, a sufficient setting speed and resulting therefrom a sufficient handling strength of the reactive adhesive can be achieved directly after adhesive application.

As optional further polyols, polyester polyols, polyether polyols and any hydroxy-functional components may be used for example. The selection of these optional polyols is arbitrary. However, the polyols used should not substantially increase the average OHN of the formulation, preferably by not more than 10%.

As optional further polyester polyols for example, liquid or solid, amorphous or (semi)crystalline polyesters may be used having molecular weights with a number average between 2000 g/mol and 30 000 g/mol, preferably between 3000 g/mol and 10 000 g/mol (calculated from the hydroxyl number), preference being given to using linear polyester polyols.

The optional polyether polyols used may be, for example, polyether diols or polyether triols. Examples of these are, for example, homo- and copolymers of ethylene glycol, propylene glycol and butane-1,4-diol. The molecular weight (number average) of the polyether polyols added should preferably be within a range from 2000 g/mol to 30 000 g/mol, preferably between 3000 g/mol and 10 000 g/mol.

The optional arbitrary hydroxy-functional components used are preferably hydroxy-functional polyolefins such as hydroxy-functional polybutadienes, hydroxy-functional polyisoprenes, hydroxy-functional polyolefins, hydroxy-functional polycarbonates or hydroxy-functional polyacrylates.

Diisocyanates used in the method according to the invention may be aromatic, aliphatic and/or cycloaliphatic isocyanates, and also carbodiimide-modified isocyanates or isocyanate-terminated prepolymers. Preference is given to using aromatic diisocyanates. Preferred diisocyanates used are diphenylmethane 4,4′-diisocyanate, diphenylmethane 2,4′-diisocyanate, toluene diisocyanate isomers, isophorone diisocyanate, hexamethylene diisocyanate, dicyclohexylmethane 4,4′-diisocyanate and mixtures thereof. Particularly preferred diisocyanates used are diphenylmethane 4,4′-diisocyanate and mixtures of diphenylmethane 4,4′-diisocyanate and diphenylmethane 2,4′-diisocyanate.

Polyisocyanates can also be used in addition to diisocyanates.

It may be advantageous if further additives are added to an extent of up to 50% by weight, preferably from 5 to 40% by weight, based on the overall formulation, particularly additives for example which ensure improved stability to hydrolysis. These additives may be, for example: non-functionalized polymers, for example thermoplastic polyurethanes (TPUs) and/or polyacrylates and/or ethylene-vinyl acetate copolymers (EVA); pigments or fillers, for example talc, silicon dioxide, titanium dioxide, barium sulfate, calcium carbonate, carbon black or color pigments; tackifiers, for example rosins, hydrocarbon resins, phenolic resins, and ageing stabilizers and auxiliaries.

In the simplest case, the reactive adhesive according to the invention is produced by mixing the individual components in a stirred vessel with or without solvent, preferably in the melt. The melting temperature is preferably dependent on the viscosity of the constituents. It is preferably within a range from 100 to 180° C.

The reactive adhesives according to the invention, depending on the viscosity of the respective formulation, are applied preferably at temperatures of 50 to 200° C., preferably 80 to 150° C.

The reactive adhesives according to the invention are particularly suitable for production of adhesive bonds of a variety of substrates, especially for bonding of metallic substrates and textiles, and very particularly for bonding of various plastics. The nature and extent of the bonding are unlimited. Preferably, the bonds are bonds in the wood and furniture industry (for example assembly bonding and the lamination of decorative films onto fiberboard), in the automotive sector (for example laminations of films or textiles onto door side parts, inner roof linings, seat manufacture and retainer bonds), in the construction industry, shoe industry and textile industry, and in window construction (for example for profile ensheathing). In addition, the adhesives of the invention are suitable in the packaging industry, as sealants and as coating material.

The reactive adhesives according to the invention are suitable both for use in one-pack systems and in two-pack systems. In the one-pack adhesives, the reaction product is produced by reacting the polyols with diisocyanate or polyisocyanate time-independently of the adhesive application, especially at a significantly earlier time point. The application of the polyurethane adhesive according to the invention is followed by curing, for example by moisture or by thermally induced reaction of the co-reactants present in the adhesive.

In the case of the two-pack adhesives, the mixture is produced directly prior to adhesive application. The drawback of two-pack application as compared with one-pack application is the increased level of technical complexity and greater proneness to error, for example in the mixing operation.

The reactive adhesives according to the invention may be used for example for bonding plastics, metals or wood or for bonding plastics to metals and/or wood. Preference is given to using the reactive adhesives according to the invention for bonding ABS, polycarbonate, PET, PMMA, PVC, wood or metals for example.

Even without further elaboration it is believed that a person skilled in the art will be able to make the widest use of the above description. The preferred embodiments and examples are therefore to be interpreted merely as a descriptive disclosure which is by no means limiting in any way whatsoever.

The subject matter of the present invention is elucidated in detail in the following examples, without any intention that the subject matter of the present invention be restricted to these.

### Examples

1. Test methods:

a) Determination of Acid Number:

The concentration of acid end groups is determined in accordance with DIN EN ISO 2114 by titrimetric means in mg KOH/g of polymer.

b) Determination of OH Number (OHN):

The concentration of the OH groups is determined in accordance with DIN 53240-2 by titrimetric means in mg KOH/g of polymer.

c) Determination of NCO Number (NCON):

The NCO number was determined in accordance with DIN EN 1242 by titrimetric means in % by weight.

d) Determination of Viscosity:

The viscosity of the polyesters produced and of the reaction products of polyester and diisocyanate was determined in accordance with DIN EN ISO 3219 in Pa·s using a rotational viscometer at the temperature specified in each case.

e) Determination of Glass Transition Temperature T_{g}:

The thermal properties of the polyesters used in the context of the present invention are determined by differential scanning calorimetry (DSC) in accordance with the DSC method DIN 53765. The values of the second heating interval are stated and the heating rate was 10 K/min.

f) Determination of Molecular Weight:

The number-average molecular weight of the polyesters according to the invention is determined in accordance with DIN 55672-1 by means of gel permeation chromatography in tetrahydrofuran as eluent and polystyrene for calibration.

g) GPC Determination of the Free MDI Monomer Content:

The content of free 4,4′-MDI was determined in % by weight by GPC using an Alliance HPLC equipped with a Waters e2695 separation module W/O H/C and Waters 2414 Ri detector, in which the following column combination was used for optimal low molecular weight separation: 2× Agilent PLgel 3 μm 100 Å 300×7.5 mm. The measurement was a measurement relative to a pure sample of 4,4′-MDI as reference.

2. Synthetic Method for Producing the Polyesters:

A mixture of diols and diacids or diacid anhydrides was melted under nitrogen in a 2 L glass flask fitted with distillation attachment in the amounts specified in Table 1. At a temperature of 240° C., the majority of the water of reaction formed was distilled off within about four to six hours. Subsequently, the reaction progress was investigated every 30 minutes by measuring the acid number. From an acid number of <15 mg KOH/g, 1.5 g of tetra-n-butyl titanate (Tytan TNBT from Borica Co., Ldt; 0.1 percent by weight based on the theoretical yield of the polyester) were added, the temperature was reduced to 230° C. and the pressure in the apparatus was lowered in stages to 10 mbar, in which the stages were selected so that strong foaming of the melt was avoided. Subsequently, the reaction progress was investigated every 30 minutes by measuring the acid number. The reaction was terminated when no acid end groups were present any longer (acid number was <1 mg KOH/g) and a concentration of hydroxyl end groups of 22±2 mg KOH/g was attained.

In accordance with the determination methods stated above, the OH number (OHN), the viscosity at 130° C. and the glass transition temperature Tg was determined for the polyesters obtained. The values determined are listed in Table 1.

TABLE 1
Amounts used and parameters of the polyesters obtained

| Example | Initial weight of | Initial weight of | | viscosity | |
|---|---|---|---|---|---|
| (polyesters) | diols (mol) | diacids (mol) | OHN | (@ 130° C.) | Tg |
| P1 (comp) | 241 g MEG (3.89 mol) | 576 g TPA (3.47 mol) | 23 | 222 Pa · s | 59° C. |
| | 405 g NPG (3.89 mol) | 576 g IPA (3.47 mol) | | | |
| P2 (comp) | 241 g MEG (3.89 mol) | 346 g TPA (2.08 mol) | 21 | 265 Pa · s | 58° C. |
| | 405 g NPG (3.89 mol) | 806 g IPA (4.86 mol) | | | |
| P3 | 241 g MEG (3.89 mol) | 576 g TPA (3.47 mol) | 23 | 60 Pa · s | 48° C. |
| | 405 g NPG (3.89 mol) | 513 g PAA (3.47 mol) | | | |
| P4 | 241 g MEG (3.89 mol) | 576 g IPA (3.47 mol) | 22 | 33 Pa · s | 47° C. |
| | 405 g NPG (3.89 mol) | 513 g PAA (3.47 mol) | | | |
| P5 | 241 g MEG (3.89 mol) | 806 g IPA (4.86 mol) | 23 | 48 Pa · s | 50° C. |
| | 405 g NPG (3.89 mol) | 308 g PAA (2.08 mol) | | | |
| P6 | 295 g MEG (4.76 mol) | 588 g IPA (3.54 mol) | 22 | 37 Pa · s | 45° C. |
| | 330 g NPG (3.17 mol) | 524 g PAA (3.54 mol) | | | |
| P7 | 244 g MEG (3.94 mol) | 524 g IPA (3.15 mol) | 22 | 38 Pa · s | 43° C. |
| | 409 g NPG (3.94 mol) | 519 g PAA (3.51 mol) | | | |
| | | 41 g SUC (0.35 mol) | | | |

MEG: ethylene glycol
NPG: neopentyl glycol
TPA: terephthalic acid
IPA: isoterephthalic acid
PAA: phthalic anhydride
SUC: succinic acid

As is apparent from Table 1, comparative examples P1 and P2 show that polyesters comprising only TPA and/or IPA as aromatic diacids, at low OHN of −22 at 130° C., have very high viscosities of >200 Pa·s.

Inventive examples P3, P4 and P6 show that by exchanging TPA or IPA for PAA, the viscosity can be considerably reduced compared to P1. Example P5, having a lower proportion of PAA as comonomer, shows this analogously compared to P2.

Example P7 shows that, in PAA-rich polymers, small proportions of aliphatic diacid are already sufficient to significantly reduce the viscosity, while the glass transition temperature is also high.

3. Reaction with Methylene Diphenyl Isocyanate to Give the Reactive Adhesive

Commercial Polymers Used:

DYNACOLL® 7150: amorphous polyester with OHN 43, T_{g}=50° C. (Evonik Resource Efficiency GmbH)

DYNACOLL® 7250: liquid polyester with OHN 21, T_{g}=−50° C. (Evonik Resource Efficiency GmbH)

In a 500 ml flange flask, 300 g of the polyol mixtures specified in Table 2 were melted at 130° C. and dried under vacuum for 45 minutes. Subsequently, the amount of diphenylmethane 4,4′-diisocyanate (Desmodur 44M—Covestro) specified in Table 2 was added in a molar OH/NCO ratio of 1:2.0 and the mixture was rapidly homogenized. For complete conversion of the co-reactants, the mixture was stirred under a protective gas atmosphere at 130° C. for 45 minutes. The moisture-curing reactive hotmelt adhesive (RHM) was then analyzed with respect to viscosity and NCO content and bottled.

TABLE 2
Amounts used and parameters of the
reactive adhesives (RHM) obtained

| | | | RHM 1 | RHM 2 | RHM 3 |
|---|---|---|---|---|---|
| | | | (inven- | (inven- | (comparative |
| | | | tive) | tive) | example) |
| P4 | OHN 22 | % by wt. | 200 g | | |
| P6 | OHN 22 | % by wt. | | 200 g | |
| DYNACOLL | OHN 43 | % by wt. | | | 200 g |
| 7150 | | | | | |
| DYNACOLL | OHN 21 | % by wt. | 100 g | 100 g | 100 g |
| 7250 | | | | | |

| Diphenylmethane 4,4′-diisocyanate | | 29 g | 29 g | 47.7 g |
|---|---|---|---|---|
| Vis 130° C., RVDV-II | Pa · s | 32 | 25 | 27 |
| Monomeric MDI (via GPC) | % by wt. | 1.6 | 1.8 | 2.8 |

As can be seen in Table 2, both inventive reactive adhesives RHM1 and RHM2 after reaction with diisocyanate have a considerably lower content of monomeric diisocyanate (MDI) compared to comparative reactive adhesive RHM 3.

1. A reactive adhesive comprising the reaction product of a polyester, constructed from the monomers A, B and C, where A=phthalic acid or phthalic anhydride, B=at least one organic acid having at least two acid groups or the corresponding anhydride or the corresponding ester, wherein B is not A, and C=at least one diol, and that the molar ratio of the monomers A to monomers B is from 1:10 to 10:1, as polyol and optionally one or more further polyols, with a diisocyanate, wherein the average OH number of the polyols used is from 10 to 30 mg KOH/g polyols, the ratio of OH of the polyols used to NCO groups of the diisocyanate used is from 1:1.2 to 1:4.0, and the reaction product has a viscosity of 1 to 200 Pa*s at 130° C.

2. The reactive adhesive according to claim 1, wherein the monomers C are selected from the group consisting of monoethylene glycol, diethylene glycol, butylethylpropanediol, 1,2-propanediol, 1,3-propanediol, 1,4-butanediol, 1,6-hexanediol, neopentyl glycol, 1,3-methylpropanediol and/or 1,5-methylpentanediol.

3. The reactive adhesive according to claim 1, wherein the monomers C comprise at least two different diols C1 and C2.

4. The reactive adhesive according to claim 1, wherein the monomers B are at least two different organic acids.

5. The reactive adhesive according to claim 1, wherein the monomer B comprises only one organic acid.

6. The reactive adhesive according to claim 1, wherein the monomer(s) B is/comprises at least one acid selected from terephthalic acid, isoterephthalic acid, adipic acid and succinic acid.

7. The reactive adhesive according to claim 1, wherein the polyester has a viscosity at 130° C. of less than 100 Pa*s.

8. The reactive adhesive according to claim 1, wherein the polyester has a glass transition temperature of 20° C. to 60° C.

9. The reactive adhesive according to claim 1, wherein the polyester has a glass transition temperature of 30+/−10° C. and a viscosity at 130° C. of less than 20 Pa*s or it has a glass transition temperature of 48+/−10° C. and a viscosity at 130° C. of less than 100 Pa*s.

10. The reactive adhesive according to claim 1, wherein said reactive adhesive has a residual content of monomeric diisocyanate, based on the sum total of reaction product and diisocyanate, of less than 2% by weight.

11. The reactive adhesive according to claim 1, wherein the diisocyanate is isomerically pure or an isomeric mixture of MDI (methylene diphenyl isocyanate).

12. The method for producing a reactive adhesive according to claim 1, wherein the monomers A, B and C are esterified, where A=phthalic acid or phthalic anhydride, B=at least one organic acid having at least two acid groups or the corresponding anhydride or the corresponding ester, with the proviso that B is not A, and C=at least one diol, wherein the molar ratio of the monomers A to monomers B is from 1:10 to 10:1, and this polyester as polyol, optionally in the presence of one or more further polyols, is reacted with at least one diisocyanate, wherein the average OH number of the polyols used is from 10 to 30 mg KOH/g polyols, the ratio of OH groups of the polyols used to NCO groups of the diisocyanates used is from 1:1.2 to 1:4.0.

13. The method according to claim 12, wherein the monomers C are selected from the group consisting of monoethylene glycol, 1,3-propanediol, 1,4-butanediol, 1,6-hexanediol, neopentyl glycol, 1,3-methylpropanediol and/or 1,5-methylpentanediol, and the monomer B used is at least one acid selected from terephthalic acid, isoterephthalic acid, adipic acid and succinic acid.

14. A composition comprising a plastic, a metal and the reactive adhesive according to claim 1 wherein the plastic is bonded to the metal by the reactive adhesive.

15. The reactive adhesive according to claim 3, wherein the monomer C1 being monoethylene glycol and the monomer C2 being neopentyl glycol or 1,3-methylpropanediol.

16. The reactive adhesive according to claim 1, wherein the polyester has a viscosity at 130° C. of less than 80 Pa*s.

17. The reactive adhesive according to claim 1, wherein the polyester has a glass transition temperature of 25° C. to 55° C.

18. The reactive adhesive according to claim 1, wherein said reactive adhesive has a residual content of monomeric diisocyanate, based on the sum total of reaction product and diisocyanate of from 0.01 to less than 1% by weight.

19. A composition comprising a plastic, a wood and the reactive adhesive according to claim 1 wherein the plastic is bonded to the wood by the reactive adhesive.

20. The reactive adhesive according to claim 1, wherein the ratio of OH of the polyols used to NCO groups of the diisocyanate used is from 1:1.6 to 1:2.5.
